(19) United States
(12) Patent Application Publication
(10) Pub. No.: US 2025/0156680 A1
(43) Pub. Date: May 15, 2025

(54) LEARNING A SEMANTIC PARSER WITH SEMI SUPERVISION

(71) Applicant: International Business Machines Corporation, Armonk, NY (US)

(72) Inventors: Maxwell Crouse, Chicago, IL (US); Ramon Fernandez Astudillo, White Plains, NY (US); Tahira Naseem, Briarcliff Manor, NY (US); Subhajit Chaudhury, White Plains, NY (US); Pavan Kapanipathi Bangalore, White Plains, NY (US); Alexander Gray, Yonkers, NY (US)

(21) Appl. No.: 18/507,605

(22) Filed: Nov. 13, 2023

(51) Int. Cl. G06N 3/0455; G06N 3/0895

(52) U.S. Cl. CPC G06N 3/0455; G06N 3/0895

(57) ABSTRACT

One or more systems, devices, computer program products and/or computer-implemented methods of use provided herein relate to scalable learning of latent language structure with logical offline cycle consistency. The computer-implemented system can comprise a memory that can store computer executable components. The computer-implemented system can further comprise a processor that can execute the computer executable components stored in the memory, wherein the computer executable components can comprise a training component that can train a semantic parser to predict one or more parses for an input text using offline reinforcement learning based on parallelizable offline sampling.

### STATEMENT REGARDING PRIOR DISCLOSURES BY THE INVENTOR OR A JOINT INVENTOR

The following disclosure(s) are submitted under 35 U.S.C. 102(b)(1)(A): DISCLOSURE(S): [Scalable Learning of Latent Language Structure with Logical Offline Cycle Consistency, Maxwell Crouse, Ramon Astudillo, Tahira Naseem, Subhajit Chaudhury, Pavan Kapanipathi, Salim Roukos, Alexander Gray, May 31, 2023].

### BACKGROUND

The subject disclosure relates to machine learning and, more specifically, to learning a semantic parser with semi supervision.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable learning a semantic parser with semi supervision are discussed.

According to an embodiment, a system is provided. The system can comprise a memory that can store computer-executable components. The system can further comprise a processor that can execute the computer-executable components stored in the memory, wherein the computer-executable components can comprise a training component that can train a semantic parser to predict one or more parses for an input text using offline reinforcement learning based on parallelizable offline sampling.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can enable learning a semantic parser with semi supervision using cycle consistency and a probabilistic reasoner in accordance with one or more embodiments described herein.

FIG. 2 illustrates a block diagram of an example, non-limiting system for semantic parsing and text generation and a structure generated via the semantic parsing in accordance with one or more embodiments described herein.

FIG. 3 illustrates a flow diagram of an example, non-limiting cycle for semantic parsing and text generation based on a BART architecture in accordance with one or more embodiments described herein.

FIG. 4 illustrates a flow diagram of an example, non-limiting system for semantic parsing and text generation using supervised training in accordance with one or more embodiments described herein.

FIG. 5 illustrates a flow diagram of an example, non-limiting system for semantic parsing and text generation using parallel unsupervised training in accordance with one or more embodiments described herein.

FIG. 6 illustrates a diagram of example, non-limiting text and structure pairs from a WebNLG dataset and a structure showing a text-to-RDF example for a WebNLG dataset in accordance with one or more embodiments described herein.

FIG. 7 illustrates a diagram of example, non-limiting text and structure pairs from an ATIS dataset in accordance with one or more embodiments described herein.

FIG. 8 illustrates an example, non-limiting graph showing results of a semantic parsing performance across training iterations in accordance with one or more embodiments described herein.

FIG. 9 illustrates a flow diagram of an example, non-limiting method that can enable learning a semantic parser with semi supervision using cycle consistency and a probabilistic reasoner in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

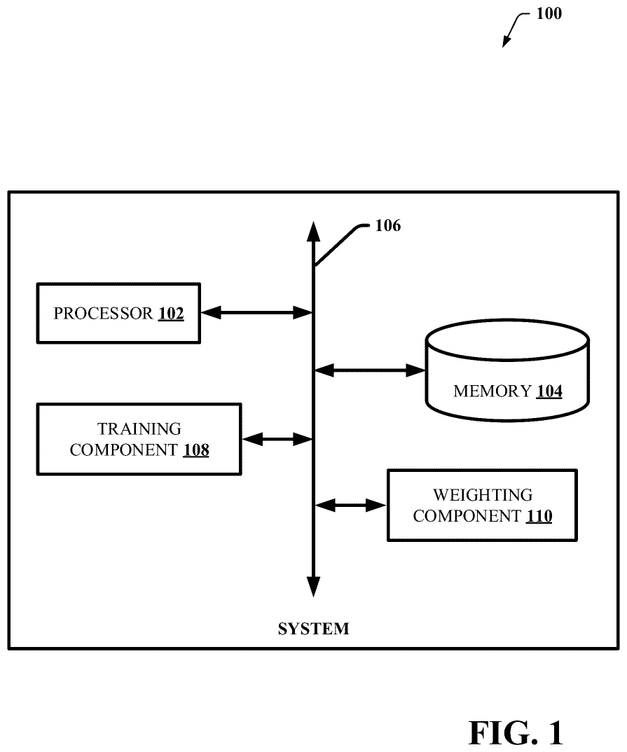

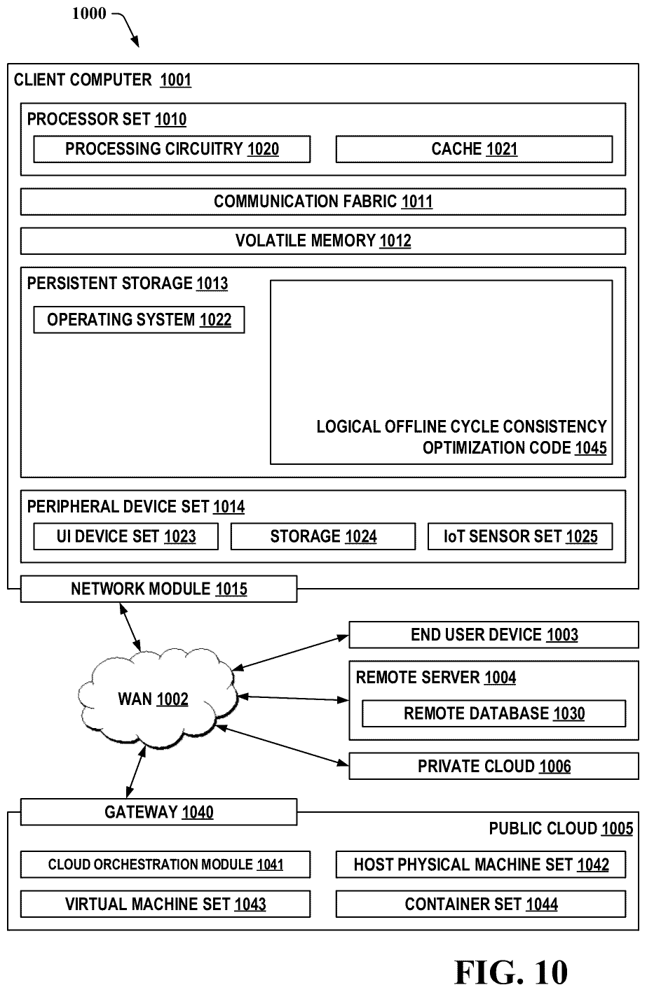

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, system 100 can be associated with, such as accessible via, a computing environment 1000 described below with reference to FIG. 10, such that aspects of processing can be distributed between system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

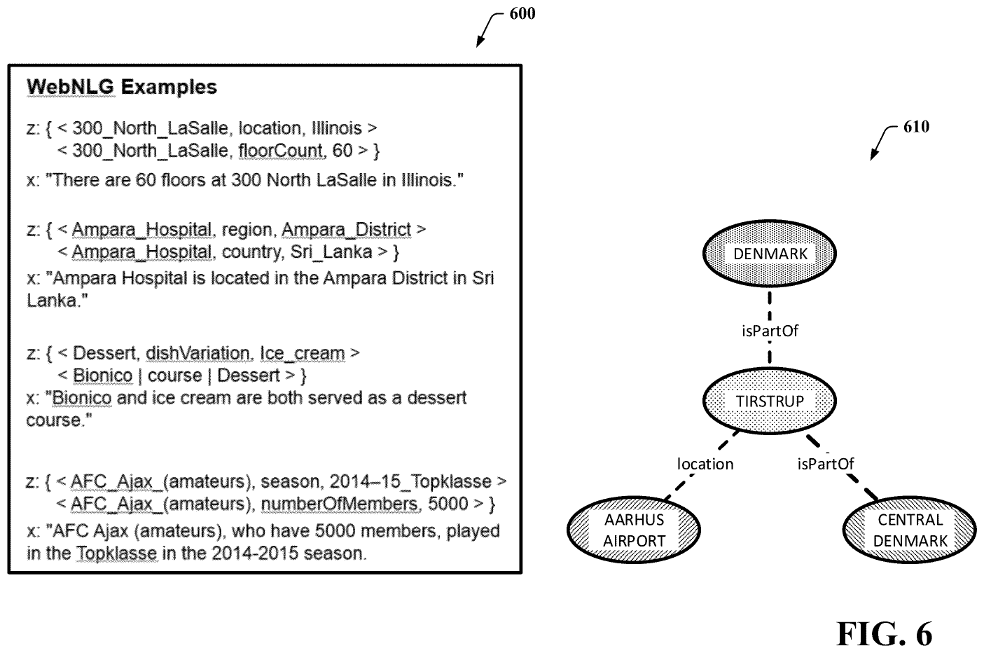

Large language models (LLMs) have brought dramatic gains to semantic parsing-related tasks, allowing for more performant systems that need significantly less effort to adapt from one domain to the next. However, while an impact of LLMs has been undeniable, LLMs still face numerous challenges. Firstly, LLMs are originally trained for text-only, sequence-to-sequence problems. In contrast, semantic parsing is inherently a text-to-structure problem, wherein the objective is to take in text as input and produce a logical form (e.g., converting natural language utterances into a logical form) that is most commonly a tree or graph (as illustrated by structure 610 of FIG. 6). Beyond a need to account for explicit structure, LLMs also need to overcome a paucity of training examples, which generally involve costly expert-level knowledge to collect in this space. That is, unlike some problem settings in NLP, semantic parsing can have a heavy data acquisition cost because annotating text with a logical form can need expert knowledge. To better generalize to formal, structured representations and alleviate data-scarcity concerns, many high performing text-to-structure and structure-to-text models employ a form of bootstrapping. That is, the text-to-structure and structure-to-text models fine-tune an initial model using supervised data is available and subsequently use the fine-tuned model to annotate a large amount of unlabeled text to serve as additional training data. This form of data augmentation is commonly referred to as self-learning, with the parsed data being referred to as pseudo-labels or silver data.

Unfortunately, using fine-tuned models to generate data is not always straightforward, since, without specific modifications most pretrained neural models do not offer any well-formedness guarantees. While some existing approaches that can be applied to simpler datasets can sidestep the issue by deriving synthetic examples from grammars induced from the supervised data, such a strategy is untenable in more realistic open-ended domains. In addition to well-formedness concerns, self-learning models also introduce noise in the labels and are known to saturate in performance relatively quickly (only one iteration of self-learning labeling and training is used in state-of-the-art systems). More elaborate approaches leveraging latent variable models can be more robust to such noise and can improve silver data quality over multiple update iterations. However, such elaborate approaches involve marginalizing over latent discrete structures, which can add significant complexity and computational overhead. In the area of parsing, there is a large corpus of literature in parse induction which often involves marginalization over latent structures. However, such approaches are focused on unsupervised cases with few works considering semi-supervised learning. Such approaches often need strong independence assumptions, for example, context-free grammars.

Various embodiments of the present disclosure can be implemented to produce a solution to one or more of the above problems. Embodiments described herein include systems, computer-implemented methods, and computer program products that can enable training a semantic parser. For example, in various embodiments, Logical Offline Cycle Consistency Optimization (LOCCO), a semi-supervised method for training a semantic parser can be implemented to address the aforementioned issues. LOCCO can predict parses for a corpus of text, however, rather than treating predicted parses as gold data, each prediction can be weighted as a function of two scores: 1) an LLM-produced cycle consistency score that can provide a strong signal indicating faithfulness of a predicted sample to an original text of the predicted sample and 2) a count-based prior probability that can assign higher scores to parses that are syntactically valid and share a common substructure with other sampled parses across the corpus. Gold data can refer to an initial set of labeled data that can be used to learn an initial model. Weighting the predictions can result in a model that can be incentivized to produce less-noisy parses, such that the parses can be both, coherent with respect to the input text, and structurally regular. LOCCO can have Stochastic Variational Inference (SVI) as a principled theoretical foundation, and LOCCO can also be related to offline reinforcement learning. Furthermore, LOCCO can be straightforward to implement, trivial to parallelize, and need very little added computational cost to standard silver data training. In addition to producing a strong semantic parser, the output annotations produced by LOCCO can also be used to train a structure-to-text model.

Various embodiments herein can translate between natural language and formal language domains, for example, parsing between text and a knowledge graph expressing the semantics of a sentence (as illustrated by structure 610 of FIG. 6) using the LOCCO method. As discussed above, LOCCO can be a scalable, semi-supervised method for training a neural semantic parser. Conceptually, LOCCO can be viewed as a form of self-learning wherein the semantic parser being trained can be used to generate annotations for unlabeled text and the annotations can later be used as new supervision. To improve a quality of annotations, LOCCO can utilize a count-based prior over valid formal meaning representations and a cycle consistency score produced by a neural text generation model as additional signals. Both the prior and semantic parser can be updated in an alternate fashion from full passes over the training data, which can be seen as approximating a marginalization of latent structures through SVI. The use of a count-based prior, frozen text generation model, and offline annotation process can yield an approach with negligible complexity and latency increases as compared to conventional self-learning. Additionally, the annotations produced by LOCCO can be trivially repurposed to train a neural text generation model. A utility of LOCCO was experimentally demonstrated on the well-known WebNLG benchmark, wherein an improvement of 2 points was obtained against a self-learning parser under equivalent conditions, an improvement of 1.3 points was obtained against a previous state-of-the-art parser, and a competitive text generation performance was obtained in terms of a BLEU score. Experimental results have been presented with reference to some of the subsequent figures.

### Cycle Consistency and Latent Variable Optimization:

End-to-end differentiable cycle consistency (CC) losses can concern two probabilistic models relating two domains p (x|z) and p (z|x), for example, text/image or text/text. The parameters of both distributions can be learned end-to-end via gradient descent to maximize [symbol] _{p(z|x)}[p(x|z)]=∫_{z∈D}_{_{z}} p(x|z)p(z|x)dz or [symbol] _{p(z|x)} [p(x|z)]=Σ_{z∈D}_{_{z}} p(x|z)p(z|x) for continuous or discrete bottleneck variables, respectively. Optimizations can be performed either for one bottleneck, that is, z, or both x and z simultaneously. CC losses can be used in a semi-supervised fashion by combining datasets where only z or x can be available with datasets where both, z, and x, available. CC can be implemented in various areas of application, including image transformation, machine translation, speech-to-text, and text-to-speech. For these domains, the expectations over the output sets can be intractable. For continuous domains such as image or speech, direct backpropagation through either reparametrization or collapsing the distribution over the mean can be possible. Although not explicitly stated, an output of the composed networks can be interpreted as a mean of a constant variance Laplace distribution, reducing to ∥x− [symbol] _{p(x|} [symbol] _{[z|x])}[x]∥₁. For discrete domains such as text or formal languages, such a direct backpropagation cannot be possible and approximations can be needed, like strong independence assumptions, straight-through approximations, a score-function estimator (e.g., REINFORCE), or collapsing the distribution to K-best.

CC losses can be related to semi-supervised end-to-end learning with latent variables when the variables correspond to interpretable domains, for example, latent summarization models, trees, and sequence labeling. In this regard, some existing approaches can be restricted to particular structures (e.g., trees) and some of the approaches need strong independence assumptions. Various embodiments herein can propose an offline version of variational inference without structure restrictions, that can learn a prior over the latent even when gradient learning is not possible (e.g., rule learning). Various embodiments herein can also integrate and outperform LLM approaches, which have generally displaced latent variable models.

Turning now to FIG. 1, illustrated is a block diagram of an example, non-limiting system 100 that can enable learning a semantic parser with semi supervision using cycle consistency and a probabilistic reasoner in accordance with one or more embodiments described herein.

In one or more embodiments, system 100 can comprise a computer-readable memory (e.g., memory 104) that can be operably connected to processor 102. Memory 104 can store computer-executable instructions that, upon execution by processor 102, can cause processor 102 and/or one or more other components of system 100 (e.g., training component 108 and/or weighting component 110) to perform one or more actions. In one or more embodiments, memory 104 can store computer-executable components (e.g., training component 108 and/or weighting component 110).

The system 100 and/or the components of the system 100 can be employed to use hardware and/or software to solve problems that are highly technical in nature (e.g., related to LLMs, semantic parsing with semi-supervision, etc.), that are not abstract and that cannot be performed as a set of mental acts by a human. Further, some of the processes performed may be performed by specialized computers for carrying out defined tasks related to learning a semantic parser with semi-supervision. The system 100 and/or components of the system can be employed to solve new problems that arise through advancements in technologies mentioned above, and/or the like. The system 100 can provide technical improvements to machine learning systems by using offline reinforcement learning based on parallelizable offline sampling to train a semantic parser to predict parses using for an input text. The offline reinforcement learning can sidestep efficiency issues involved in online sampling, because sampling can be a time-consuming part of using reinforcement learning in an online setting for semantic parsing.

Discussion turns briefly to processor 102, memory 104 and bus 106 of system 100. For example, in one or more embodiments, system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

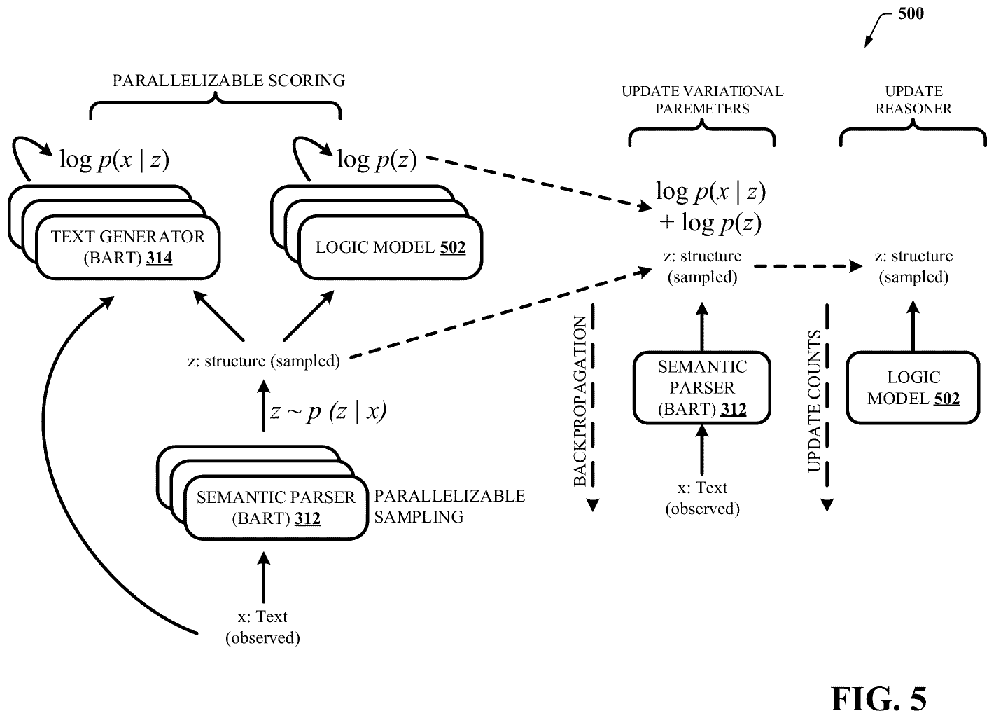

In addition to processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, in various embodiments, training component 108 can train a semantic parser (e.g., semantic parser 312 in FIG. 5) to predict one or more parses (i.e., one or more semantic parses) for an input text using offline reinforcement learning based on parallelizable offline sampling. Herein, the semantic parser can be used to translate text to a data structure that can reside in/be stored in a computer. The data structure can have various applications, and the data structure can most commonly be used for querying. For example, the data structure can have a logical form, and the logical form can be executed to return an answer to a question against a particular database, or the logical form can be some fact about the world that can be stored in a structured knowledge base, and so on. The data structure can be described as a structure that can obey grammar and be formally described, for example, as opposed to natural language which is not formally described. Thus, a semantic parser can be used to translate natural language text into a logical form that can be a meaning representation of the original natural language text that can be employed to perform tasks. In general, semantic parsing can be defined as a process of transforming natural language into a data representation (e.g., text to data) that can be formally described, such as a programming language or a form of linguistic abstraction such as semantic parses (e.g., trees, directed acyclic graphs (DAGs), etc.).

The semantic parser can be an LLM-based semantic parser, and system 100 can interact with an off-the-shelf LLM (e.g., a BART pretrained model) to boost capabilities of the LLM for semantic parsing and text generation by training the semantic parser. Pretrained LLMs can be massive neural networks pretrained on a large amount of data, and previously unseen or unexpected capabilities of such pretrained LLMs can be unlocked by providing additional data to such LLMs. Thus, to design an LLM-based semantic parsing and text generation system (hereinafter, LLM-based system) that can demonstrate additional capabilities, various embodiments herein can enable training an LLM-based semantic parser with a large amount of data (e.g., to make the best possible semantic parser). The semantic parser (e.g., LLM-based semantic parser) can be trained to translate text to structured representations (i.e., text-to-structure or Text2Struc). Additional capabilities of the LLM-based system can include translation from structured representations back to text (i.e., structure-to-text or Struc2Text).

Designing a semantic parser that can be more performant than a traditional semantic parser can be achieved by teaching the semantic parser on significantly more data than a regular dataset used for a domain specific logical form. However, training a semantic parser can be a challenging process as compared to some other natural language processing (NLP) problems because training a semantic parser can involve mapping to a logical form instead of a standard sequence-to-sequence form, because of which, there can be a lack of training data. For example, standard LLMs can be tailored for sequence-to-sequence problems that can pose challenges when structured data is either a source or a target representation, and gathering sufficient data can be difficult since annotation can involve expert knowledge. That is, for semantic parsing involving translating text to a structured representation, acquiring training data can be difficult because generating the training data can involve an expert that can parse language into a structured representation. For example, generating the training data for a semantic parser can need an individual fluent in a programming language or individuals that can understand a logic scheme of an underlying knowledge graph (e.g., if the semantic parser is designed to map text to logic). Thus, the training data for training a semantic parser can be limited to a small dataset due to lack of a large amount of data that the semantic parser can be trained on to unlock abilities of the LLM-based system.

To acquire such large data to train a semantic parser, various embodiments herein can introduce a cycle consistency (CC) task via the LOCCO method described above, instead of only training the LLM-based system with pairings of text and structure from an existing dataset. Various embodiments herein can use a standard sequence-to-sequence foundation model (e.g., a BART pretrained model) as the LLM, although other LLMs can be used in other embodiments. For the CC task, embodiments herein can consider a large set of unannotated text that can comprise sentences, and the LLM-based semantic parser can be used to annotate the unannotated text via semantic parsing. As a result, a new dataset comprising text paired with semantic parses can be generated, and training component 108 can train the LLM-based semantic parser on the new dataset. The trained LLM-based semantic parser can generate noisy semantic parses because the LLM-based semantic parser can be trained on self-produced data (e.g., data produced by the LLM-based semantic parser). To combat this issue, various embodiments herein can introduce a scoring system to evaluate a quality of each example (e.g., semantic parser) generated by the LLM-based semantic parser, as described below.

In various embodiments, weighting component 110 can weight respective parses of the one or more parses generated by the semantic parser as functions of an LLM-produced cycle consistency score that can indicate respective levels of coherence of the respective parses to the input text. For example, upon sampling from the LLM-based semantic parser, that is, upon generation of the respective parses by the semantic parser, an LLM-based text generator can assign the LLM-produced cycle consistency score, log p(x|z), to each parse, and weighting component 110 can weight each parse as a function of the assigned LLM-produced cycle consistency score. Thus, the LLM-based text generator can be used to gauge likelihood of an original text, x, given a semantic parse, z. In an aspect, weighting the respective parses of the one or more parses as functions of an LLM-produced cycle consistency score can result in a model that can produce parses that are coherent with respect to the input text.

In various embodiments, weighting component 110 can further weight the respective parses as functions of a count-based prior probability that can assign scores above a defined threshold to parses that are syntactically valid and share a common substructure with the one or more parses. For example, a logic model (e.g., logic model 502 of FIG. 5/a count-based model or reasoner) can assign a count-based score, log p(z), to the respective parses, in isolation of the text, x. The logic model can assign the count-based score to each parse without involving the BART model, and weighting component 110 can weight each parse as a function of the count-based prior probability. In an aspect, weighting the respective parses as functions of the count-based prior probability can result in a model that can produce structurally regular parses.

Thus, an overall score for each semantic parse generated by the LLM-based semantic parser can be a sum of the LLM-based cycle consistency score and the count-based score. Further, the LLM-based semantic parser can assign an encoding entropy score, H(q), to each semantic parse. Weighting the respective parses can generate additional data at a scale that can assist with unlocking additional abilities of the LLM-based system. Further, weighting the respective parses can ensure that the additional data generated does not hurt the LLM-based system (e.g., via the scoring function that can assess the quality of each example produced). For example, the LLM-based semantic parser can generate a semantic parse based on the unannotated data, wherein the semantic parse can be unrelated to the original input text, and the overall score can assign a lower rating to the unrelated semantic parse such that weighting component 110 can down weight the unrelated semantic parse. Subsequently, training (e.g., by training component 108) the LLM-based system on the unrelated semantic parse can have a minimal effect on the LLM-based system, which can assist in scaling data up to an amount needed to unlock additional capabilities of the LLM-based system without distracting the LLM-based system with noisy inputs.

As stated elsewhere herein, training component 108 can train the semantic parser using offline reinforcement learning based on parallelizable offline sampling. The parallelizable offline sampling can allow the CC task to be executed in a speedy manner and the parallelizable offline sampling can be scaled, such that more data can be added as the LLM-based semantic parser is trained. In various embodiments, the offline reinforcement learning based on the parallelizable offline sampling can generate a self-annotated dataset. In an aspect, the LLM-based text generator (e.g., text generator 314) can be trained on the self-annotated dataset. For example, the BART architecture can be initially trained on a small set of gold data available to initialize the BART model for semantic parsing, and the trained BART model can be used to parse a large set of unannotated data comprising unannotated text, x, into a structured representation, z. The semantic parser of the BART model (e.g., LLM-based semantic parser) can learn from a set of gold supervised data when available and learn latent structure, z from text, x when gold data is not available. Thereafter, the text generator of the BART model (e.g., LLM-based text generator) can be used to determine how likely the original text can be, given the structured representation, wherein the likelihood of text, x, given structure, z, can represent a component of an overall score assigned to each semantic parse. In other words, the BART model can be used to determine likelihood of x given z, and the probability output by the LLM-based text generator can form a component of the overall score. It is to be appreciated that the LLM-based cycle consistency score can be assigned to each semantic parse without sampling from the LLM-based text generator.

Thus, system 100 can develop an LLM-based system that can translate natural language sentences to and from symbolic representations. The LLM-based system can utilize a BART architecture to learn text-to-structure and structure-to-text translations from available supervised data. Based on the learned text-to-structure and structure-to-text translations, system 100 can augment training (e.g., using training component 108) of the LLM-based system with a cycle consistency task to alleviate lack of gold data. Augmenting the training can comprise implementing unsupervised loss as SVI, performing offline sampling and scoring of each unlabeled training example, and scaling-up to foundation-model sizes using only a limited amount of supervision.

Offline reinforcement learning can allow the various embodiments herein to sidestep efficiency issues involved in online sampling and learn and utilize corpus-level statistics for logical forms. Learning the text-to-structure and structure-to-text translations can comprise learning from a set of gold supervised data when available and learning latent structure, z from text, x when gold data is not available. Learning the text-to-structure and structure-to-text can further comprise incorporating reasoners (e.g., logic model 502) into the training. Numerous opportunities for incorporating reasoners can exist. For example, incorporating reasoners can involve flexible incorporation of reasoners as a reward or variational distribution factor, wherein reasoner parameters can be learned by gradient-based methods, and wherein reasoners/reasoning can be used as a filter on generated forms. The LLM-based system can use any reasoner that can be capable of assigning scores to its inputs, without needing backpropagation compatibility.

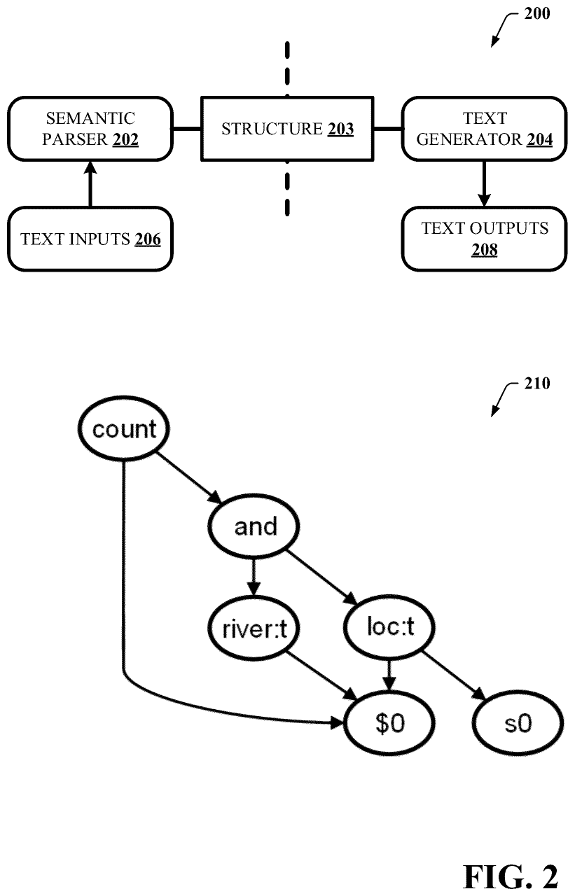

FIG. 2 illustrates a block diagram of an example, non-limiting system 200 for semantic parsing and text generation and a structure generated via the semantic parsing in accordance with one or more embodiments described herein. One or more embodiments described with respect to FIG. 2 can be performed by one or more components of FIG. 1. Repetitive description of like elements and/or processes employed in respective embodiments is omitted for sake of brevity.

Various embodiments herein can enable LOCCO, a method for training a semantic parsing and text generation system with offline reinforcement learning that can use parallelizable offline sampling to generate annotations for unlabeled text, wherein the annotations can be used as new supervision. Further, the LOCCO method can integrate with any off-the-shelf LLM to boost capabilities of the LLM for semantic parsing and text generation and output a dataset of model-sampled parses. Each parse of the model-sampled parses can be weighted as a function of an LLM-produced cycle consistency score that can provide a strong signal as to how faithful a predicted sample can be to an original text and a learned logic-model prior probability that can assign higher scores to parses that are syntactically valid and share common substructure with other sampled parses across the corpus.

In various embodiments, the LOCCO method can comprise a simple semi-supervised algorithm, based on SVI and semi-amortized Variational Inference, that can fulfill a desiderata of providing an algorithm for parsing between text, x, and formal structured representations, z (i.e., text-to-structure and structure-to-text) by leveraging strong pretrained transformer models (e.g., BART or T5) to learn functions mapping x->z and z->x, scaling training to large data sizes, which can imply overcoming a lack of paired (x, z) data samples, incorporating arbitrary constraints into a formal domain D_{z}, that can be reluctant to gradient-based learning, and further updating these during training (e.g., by training component 108). As such, various embodiments herein can utilize neural network pretraining technologies as well as available inductive biases and learning algorithms in the formal domain. The semi-supervised algorithm can reduce to standard cycle consistency or self-learning under some simplifications but outperform both algorithms under the same experimental conditions.

In various embodiments, training component 108 can train semantic parser 202 to use the semi-supervised algorithm to convert text inputs 206 to structure 203, and text generator (BART) 204 (or text generator 204) can convert structure 203 to text outputs 208. With continued reference to FIG. 1, semantic parser 202 can be used to translate text inputs 206 to structure 203 that can reside in/be stored in a computer. Structure 203 can have various applications, and structure 203 can most commonly be used for querying. For example, structure 203 can be executed to return an answer to a question against a particular database or structure 203 can be some fact about the world that can be stored in a structured knowledge base, and so on. In general, structure 203 can be described as a structure that can obey grammar and be formally described, for example, as opposed to natural language. For example, semantic parser 202 can be used to translate natural language text (e.g., text inputs 206) into a logical form that can be a meaning representation of the original natural language text, wherein the logical form can be employed to perform tasks. For example, semantic parser 202 can produce structure 203 given a natural language utterance, “How many rivers are in s0?” and structure 203 can be used to generate a response for the natural language utterance. Thus, semantic parsing can be defined as transforming natural language into a data representation (e.g., text to data) that can be formally described, such as a programming language or a form of linguistic abstraction such as semantic parses.

An example of structure 203 can be illustrated at 210. Structure 203 can be a semantic parse produced by semantic parser 202, and structure 203 can be a tree or a DAG. Since the foundation model (e.g., BART) can produce sequences, the trees or DAGs can need linearizing, wherein a tree or a DAG can be treated like a sequence and tokens can be used to indicate various sub-expressions within the tree or the DAG. Thus, the BART model can decode a sequence that can be transformed into a tree.

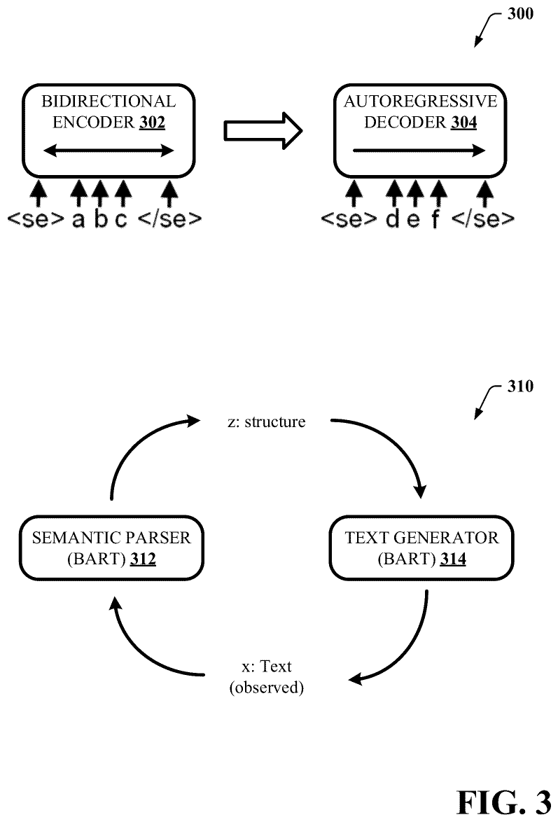

FIG. 3 illustrates a flow diagram of an example, non-limiting cycle 310 for semantic parsing and text generation based on BART architecture 300 in accordance with one or more embodiments described herein. One or more embodiments described with respect to FIG. 3 can be performed by one or more components of FIG. 1. Repetitive description of like elements and/or processes employed in respective embodiments is omitted for sake of brevity.

As described in various embodiments, pretrained LLMs can be massive neural networks pretrained on a large amount of data, and previously unseen or unexpected capabilities of such pretrained LLMs can be unlocked by providing more data to such pretrained LLMs. With continued reference to FIG. 1, various embodiments herein can enable training (e.g., by training component 108) an LLM-based semantic parser (e.g., semantic parser (BART) 312 or semantic parser 312) with a large amount of data to design an LLM-based system (i.e., an LLM-based semantic parsing and text generation system) that can demonstrate additional capabilities. Semantic parser 312 can be trained to translate text, x, to structured representations, z. Listed below are examples of text, x, converted to data, z for different datasets (e.g., FunQL Logical Forms, AMR, DBpedia Triples, SPARQL). Designing semantic parser 312 to be more performant than a traditional semantic parser can be achieved by teaching semantic parser 312 on significantly more data than a regular dataset used for a domain specific logical form. As such, various embodiments herein can aim to develop an LLM-based system that can translate between text and symbolic, structured representations, be flexible regarding particular flavors of symbolic representations (e.g., triples, FOL logic, etc.), and can model text well.

Examples of text converted to data:

Functional Query Language (FunQL) Logical Forms

z: (count (and (river:t $0) (loc:t $0 s0)))
x: “How many rivers in s0?”

### Abstract Meaning Representation (AMR

z: (r / river~2 :quant (a / amr-unknown~1) :location s0~5)
x: “How many rivers in s0?”

### DBpedia Triples

z: { < 20_Fenchurch_Street, location, London >
< London, leaderTitle, European_Parliament > }
x: “20 Fenchurch Street is located in London, which is currently led by the
European Parliament.

### SPARQL Protocol and Resource Description Framework (RDF) Query Language (SPARQL)

```
z: SELECT count ( * ) WHERE {
  ?x0 a film.film_art_director .
  M1 film.performance.actor ?x0 .
  M1 film.performance.actor M2
  }
x: “Did M1 star M2 and star an art director?”
```

Various embodiments herein can use a BART pretrained model as the LLM for the LLM-based system, although other LLMs can be used in other embodiments. BART architecture 300 can illustrate an architecture of the pretrained BART model. As stated elsewhere herein, BART can be a sequence-to-sequence model that can ingest sequences of tokens, for example, a-b-c, to produce tokens d-e-f, given a-b-c. BART architecture 300 can comprise bidirectional encoder 302 and autoregressive decoder 304. The tokens can be string representations of a semantic parse produced by BART architecture 300 based on an input text. In BART architecture 300, <se> and </se> can represent start and stop tokens with the input string enclosed between <se> and </se> in the middle.

With continued reference to FIG. 1, various embodiments herein can introduce a CC task, instead of only training the LLM-based system with pairings of text and structure from an existing dataset, to acquire the amount of data needed to train semantic parser 312. For the CC task, embodiments herein can consider a large set of unannotated text that can comprise sentences, and semantic parser 312 can be used to annotate the unannotated text, x, via semantic parsing. As a result, a new dataset comprising text paired with semantic parses can be generated, and training component 108 can train semantic parser 312 on the new dataset. As a result of semantic parser 312 being trained on self-produced data, semantic parser 312 can generate noisy semantic parses. To combat this issue, various embodiments herein can introduce a scoring system to evaluate a quality of each example (e.g., semantic parse) generated by semantic parser 312.

In various embodiments, weighting component 110 can weight respective parses of the one or more parses generated by semantic parser 312 as functions of an LLM-produced cycle consistency score that can indicate respective levels of coherence of the respective parses to the input text. For example, upon generation of the respective parses by semantic parser 312, text generator 314 can assign the LLM-produced cycle consistency score, log p(x|z), to each parse, and weighting component 110 can weight each parse as a function of the LLM-produced cycle consistency score. Thus, text generator 314 can be used to gauge likelihood of the original text, x, given a semantic parse, z. In an aspect, weighting the respective parses of the one or more parses as functions of an LLM-produced cycle consistency score can result in a model that can produce parses that are coherent with respect to the input text.

In various embodiments, weighting component 110 can further weight the respective parses as functions of a count-based prior probability that can assign scores above a defined threshold to parses that are syntactically valid and share a common substructure with the one or more parses. For example, a logic model (e.g., a count-based model or reasoner) can assign a count-based score, log p(z), to the respective parses, in isolation of the text, x. The logic model can assign the count-based score to each parse without involving the BART model, and weighting component 110 can weight each parse as a function of the count-based prior probability. In an aspect, weighting the respective parses as functions of the count-based prior probability can result in a model that can produce structurally regular parses.

Thus, a score assigned to each semantic parse generated by semantic parser 312 can be a sum of the LLM-based cycle consistency score and the count-based score. Further, semantic parser 312 can assign an encoding entropy score, H(q), to each semantic parse. In As such, cycle 310 can represent the overall score for each semantic parse produced from unannotated data.

Weighting the respective parses can generate additional data at a scale that can assist with unlocking additional abilities of the LLM-based system. Further, weighting the respective parses can ensure that the additional data generated does not hurt the LLM-based system (e.g., via the scoring function that can assess the quality of each example produced). For example, semantic parser 312 can generate a semantic parse based on the unannotated data, wherein the semantic parse can be unrelated to the original input text, and the overall score can assign a lower rating to the unrelated semantic parse such that weighting component 110 can down weight the unrelated semantic parse. Subsequently, training (e.g., by training component 108) the LLM-based system on the unrelated semantic parse can have a minimal effect on the LLM-based system, which can assist in scaling data up to an amount needed to unlock additional capabilities of the LLM-based system without distracting the LLM-based system with noisy inputs.

As stated elsewhere herein, training component 108 can train semantic parser 312 using offline reinforcement learning based on parallelizable offline sampling. The parallelizable offline sampling can allow the CC task to be executed in a speedy manner, and the parallelizable offline sampling can be scaled, such that more data can be added as semantic parser 312 is trained (e.g., by training component 108). In various embodiments, the offline reinforcement learning based on the parallelizable offline sampling can generate a self-annotated dataset. In an aspect, text generator 314 can be trained on the self-annotated dataset. For example, semantic parser 312 can be initially trained on a small set of gold data available to initialize the BART model. Thereafter, semantic parser 312 can be used to parse a large set of unannotated data comprising unannotated text, x, into a structured representation, z, and text generator 314 can be used to determine how likely the original text is given, wherein the likelihood of x given z can represent a component of an overall score assigned to each semantic parse. In other words, the BART model can be used to determine likelihood of x given z, and the probability output by text generator 314 can form a component of the overall score. It is to be appreciated that the LLM-based cycle consistency score can be assigned to each semantic parse without sampling from text generator 314. As such, cycle 310 can be representative of the overall score for each semantic parse produced from unannotated data.

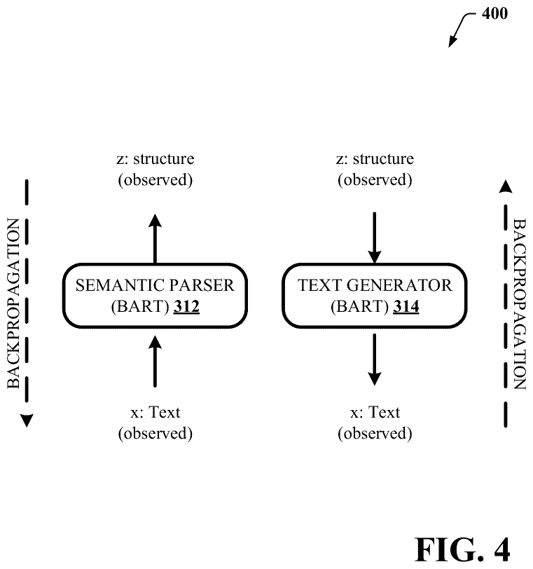

FIG. 4 illustrates a flow diagram of an example, non-limiting system 400 for semantic parsing and text generation using supervised training in accordance with one or more embodiments described herein. Repetitive description of like elements and/or processes employed in respective embodiments is omitted for sake of brevity.

With continued reference to FIG. 2, various embodiments herein can introduce a semi-supervised algorithm for parsing between text, x, and formal structured representations, z (i.e., text-to-structure and structure-to-text) by leveraging strong pretrained transformer models (e.g., BART or T5) to learn functions mapping x->z and z->x, scaling training to large data sizes, which can imply overcoming a lack of paired (x, z) data samples, incorporating arbitrary constraints into the formal domain D_{z}, that can be reluctant to gradient-based learning, and further updating these during training. The semi-supervised algorithm can reduce to a standard cycle consistency or self-learning under some simplifications but outperform both algorithms under the same experimental conditions.

Contrary to the semi-supervised method employed by embodiments of the present disclosure, system 400 illustrates a supervised training architecture for building an LLM-based system (i.e., an LLM-based semantic parsing and text generation system). In the supervised case, text, x, and structure, z, can be provided and semantic parser 312 can be trained to produce the structure, z, given x. Similarly, text generator 314 can be trained to produce text, x, given structure, z. Thus, in a standard supervised training architecture, both text, x, and structure, z can be observed.

FIG. 5 illustrates a flow diagram of an example, non-limiting system 500 for semantic parsing and text generation using parallel unsupervised training in accordance with one or more embodiments described herein. One or more embodiments described with respect to FIG. 5 can be performed by one or more components of FIG. 1. Repetitive description of like elements and/or processes employed in respective embodiments is omitted for sake of brevity.

Various embodiments herein can enable development of a large-scale semantic parsing and text generation system (e.g., system 500) that can translate natural language sentences to/from symbolic representations (e.g., Text2Struct/Struct2Text) while leveraging large quantities of available unlabeled text for better performance of system 500. As stated elsewhere herein, capabilities of LLMs for semantic parsing and text generation can be unlocked with large amounts of unlabeled data that can be leveraged by employing a semantic parser (e.g., semantic parser 312) to predict latent structure from text and using the predictions as training data for the semantic parser.

With continued reference to FIG. 3, system 500 can be an LLM-based semantic parsing and text generation system that can be designed by training (e.g., by training component 108) semantic parser 312 with a large amount of data, using the LOCCO method. In various embodiments, given text, x, structure, z, can be sampled (z˜p (z|x)) in parallel from semantic parser 312, and several different predictions can be generated for the given x. Each prediction or semantic parse can be scored with text generator 314 and logic model 502 (or reasoner), wherein text generator 314 can produce an LLM-based cycle consistency score (e.g., log p(x|z)) and logic model 502 can produce a count-based score (e.g., log p(z)). The LLM-based cycle consistency score and the count-based score can be added to form an overall score for a semantic parse generated by semantic parser 312, and the overall score can represent a standard supervised score, wherein semantic parses, z, produced by semantic parser 312 can be weighted (e.g., by weighting component 110) such that good semantic parses (e.g., semantic parses related to text, x) can be upweighted and poor semantic parses (e.g., semantic parses unrelated to text, x) can be down weighted.

In FIG. 5, “update variational parameters” refers to updating semantic parser 312 and “update reasoner” refers to updating logic model 502 because semantic parser 312 can operate in iterations wherein after training (e.g., by training component 108) semantic parser 312, the original unannotated data can be reparsed with semantic parser 312 (e.g., the trained semantic parser 312), the semantic parses generated thereafter can be weighted (e.g., by weighting component 110) and semantic parser 312 (e.g., the trained semantic parser 312) can be retrained based on the weighted semantic parses. Thus, an iterative improvement process can be implemented wherein semantic parser 312 can be trained in iterations to reparse unannotated data. Upon generation of the final dataset (e.g., the final self-annotated dataset) by semantic parser 312, the final dataset can be used to train text generator 314 such that the input to text generator 314 can be the structure, z, and the output can be text, x. It was experimentally observed that improvement in semantic parser 312 tapered at about 3 iterations for a particular dataset. While there can be a limit up to which semantic parser 312 can be improved based on the iterations, it was observed that using the overall score (i.e., a sum of the LLM-based cycle consistency score and the count-based score) can improve semantic parser 312 more consistently as compared to not using the overall score. For example, not using the overall score can improve semantic parser 312 initially before the performance of semantic parser 312 begins to degrade, however, using the overall score can continue to improve the performance of semantic parser 312 for a threshold number of iterations, based on the dataset used. Additional aspects of the various embodiments herein are described hereinafter.

### LOCCO:

LOCCO can begin by assuming access to supervised data consisting of pairs of plain text x and formal, structured representations z i.e., (x, z) ∈ [symbol] . In addition, access to much larger quantities of only text, i.e., x ∈ [symbol] can also be assumed. LOCCO can begin from a probability distribution over sentences that can arise from marginalizing over the space of all latent structures D_{z}, e.g., all knowledge-graphs.

$$p ( x ; θ ) = {\sum }_{z ∈ {D}_{z}} p ( x , z ; θ ) \qquad Equation 1$$

Following a variational formulation, the marginalization can be expressed in terms of an Evidence Lower Bound (ELBO) and reformulated in a manner that can resemble a cycle consistency loss, as given by Equations 2, 3 and 4.

$$log p ( x ; θ ) \geq {\overbrace{log p ( x ; θ ) - KL ( q ( z \vert x ; ϕ ) ‖ p ( z \vert x ; θ ) )}}^{ELBO} \qquad Equation 2$$

$$= {𝔼}_{z \sim q ( z \vert x ; ϕ )} [ log p ( x \vert z ; θ ) ] - KL ( q ( z \vert x ; ϕ ) ‖ p ( z ; θ ) ) \qquad Equation 3$$

$$= {𝔼}_{{\underbrace{z \sim q ( z \vert x ; ϕ )}}_{text - to - structure}} [ {\underbrace{log p ( x \vert z ; θ )}}_{structure - to - text} + {\underbrace{log p ( z ; θ )}}_{reasoner} ] + {\underbrace{H ( {q}_{ϕ} )}}_{encoding entropy} \qquad Equation 4$$

where KL( ) is the Kullback-Leibler divergence and H( ) the entropy.

Equation 4 can be alternately written as:

$$log p ( x ) = log {𝔼}_{z \sim p ( z )} \{ p ( x \vert z ) \} \geq {𝔼}_{{\underbrace{z \sim q ( Z \vert X )}}_{text - to - structure}} \{ {\underbrace{log p ( x \vert z )}}_{structure - to - text} + {\underbrace{log p ( z )}}_{reasoner} ] + {\underbrace{H ( q )}}_{encoding entropy}$$

Variational methods can alternate between maximizing the ELBO with respect to ϕ, bringing the ELBO closer to the marginal log-likelihood for current θⁱ, and maximizing the ELBO with respect to θⁱ. From Equation 2, it can be evident that setting a q_{ϕ} equal to the posterior p(z|x; θ) can make the bound tight yielding Expectation Maximization. In this context, q_{ϕ} can represent an auxiliary distribution that can be recomputed for each update of θ. With neural networks, an alternate optimization of ϕ and θ with gradient ascent can become costly. SVI can alleviate the issue of expensive alternate optimization with updates based on a subset of the data, however, SVI can involve a large number of optimization steps, and SVI can present optimization problems. A-VI, best exemplified by VAEs, can solve this issue by reusing q_{ϕ} across all steps of optimization of θ and simultaneously updating θ and ϕ via the gradient ascent of Equation 3. VAEs can set a parameter-less prior p(z) and not update it during training. Various embodiments herein can take the formulation of Equation 4 and the following design choices:

q(z|x; ϕ) can be parametrized by an LLM with pretrained parameter Ω that can map natural language to formal descriptions, that is, semantic parser 312.

p (x|z; φ can be parametrized with a separate copy of Ω, and p(x|z; ρ) can act as a conditional language model that can be frozen after initialization to prevent adaptation to faulty structures. Herein, it is to be noted that θ from q(z|x; ϕ) has been replaced with p to reflect separate parameters.

p(z; θ) can be a count-based model factorizing the space of possible substructures (e.g., into edges). p(z; θ) can incorporate prior knowledge about a formal language, such as valid statements.

As an initial step, all models (z|x; ϕ), p(x|z; ρ) and p(z; θ) can be fine-tuned or trained with the labeled dataset [symbol] of (x, z) pairs.

Thereafter, optimizing ϕ and θ can be alternated (e.g., as in SVI), but on full passes over the unlabeled [symbol] . A counts estimator can also be used for θ, not gradient, and [symbol] can be added for regularization.

q(z|x; ϕ) can be amortized (e.g., as in VAEs), wherein the inference network parameters are not reset after each update of θ, being thus close to semi-amortized VAEs.

As detailed in Algorithm 1, various embodiments herein can, therefore, combine alternate updates of parameters of SVI, but with full passes over the entire [symbol] ∪ [symbol] with a count-based update. Such an approach can result in both, negligible overhead, and low variance, due to the large number of samples. Text-to-structure can be a many-to-one mapping that can make a count-based model (e.g., logic model 502) a good choice, that is, there can be fewer labels than for the text counterpart. With a uniform p(z; θ), LOCCO can reduce to cycle consistency, albeit with offline updates and a frozen conditional language model, as opposed to traditional cycle consistency. With a uniform p (x|z; ρ) LOCCO can reduce to conventional self-learning. It is to be appreciated that in Algorithm 1, gradient updates shown are Stochastic Gradient Descent.

Algorithm 1: Logical Offline Cycle Consistency Optimization (LOCCO)

procedure LOCCO( [symbol] , [symbol] , q(z|x; ϕ), p(x|z; ρ), p(z; θ), Ω, K)

| | |
|---|---|
| ρ ← Ω | [symbol] Initialization |

ϕ⁰ ← Ω

| | |
|---|---|
| for batch B sampled without replacement from [symbol] do | [symbol] Supervised Warm-up |

$\begin{matrix}ρ ← ρ + η \cdot \frac{1}{\vert B \vert} {\sum }_{( x , z ) ∈ B} {∇}_{ρ} log p ( x \vert z ; {ρ}_{k} ) \\ {ϕ}^{0} ← {ϕ}^{0} + η \cdot \frac{1}{\vert B \vert} {\sum }_{( x , z ) ∈ B} {∇}_{{ϕ}^{0}} log q ( z \vert x ; {ϕ}^{0} )\end{matrix}$

end for

| | |
|---|---|
| for (x, z) ∈ [symbol] do | [symbol] Parts counts Θₛ⁰ initially set to 0 |

```
    Θₛ⁰ ← Θₛ⁰ + 1 for s ∈ parts(z)
  end for
  ${θ}_{s}^{0} = \frac{{Θ}_{s}^{0}}{{\sum }_{{s}^{′}} {Θ}_{{s}^{′}}^{0}}$
```

| | |
|---|---|
| for CC iteration i ∈ [1, K] do | [symbol] Semi-supervised Training |
| [symbol] ← ∅ | [symbol] Offline Inference Network Update |

for x ∈ [symbol] do

| | |
|---|---|
| for zⱼ ~ q(z\|x; ϕⁱ⁻¹) do | [symbol] Draw N samples |

```
        vⱼ = logp(x|zⱼ; ρ) + logp(zⱼ; θⁱ⁻¹) - logq(zⱼ|x; ϕⁱ⁻¹) [symbol]
        ← [symbol]  ∪ { (x, zⱼ, vⱼ) }
        Θₛⁱ ← Θₛⁱ + 1 for s ∈ parts(zⱼ)
      end for
    end for
    for batch B sampled without replacement from [symbol]  ∪ [symbol]  do
      ${ϕ}^{i} ← {ϕ}^{i} + η \cdot \frac{1}{\vert B \vert \vert N \vert} {\sum }_{x ∈ B} {\sum }_{( x , {z}_{n} , {R}_{n} ) ∈ {ℛ}_{i}} {R}_{n} {∇}_{{ϕ}^{i}} log q ( {z}_{n} \vert x ; {ϕ}^{i} )$
    end for
```

| | |
|---|---|
| ${θ}_{s}^{i} = \frac{{Θ}_{s}^{i}}{{\sum }_{{s}^{′}} {Θ}_{{s}^{′}}^{i}}$ | [symbol] Logic Prior Update |

end for
end procedure

A gradient update of q (z|x; ϕⁱ) can include an expectation over a set z ∈ D_{z} that is exponentially large as a function of the input (e.g., graphs) and can need back-propagating through p (x|z; φ and p(z; θ). This can be overcome with the score function estimator that can yield the following Monte Carlo approximation for the gradient

$${∇}_{{ϕ}^{i}} {𝔼}_{z \sim q ( z \vert x ; {ϕ}^{i} )} [ V ( z , x ) ] = {𝔼}_{q ( z \vert x ; {ϕ}^{i} )} [ V ( z , x ) {∇}_{{ϕ}^{i}} log q ( z \vert x ; {ϕ}^{i} ) ] \approx \frac{1}{N} {\sum }_{n = 1}^{N} V ( {z}_{n} , x ) {∇}_{{ϕ}^{i}} log q ( {z}_{n} \vert x ; {ϕ}^{i} ) , {z}_{n} \sim q ( z \vert x ; {ϕ}^{i - 1} ) ,$$

where the additional offline assumption of ϕⁱ≈ϕⁱ⁻¹ can be made for the purpose of sampling, and V(z, x)=log p(x|z; φ+log p(z; θⁱ⁻¹)−log q(z|x; ϕⁱ⁻¹). It is to be appreciated that the entropy term H(q_{ϕ}) was empirically observed to have no effect and was removed.

This can amount to updating ϕⁱ with samples from the previous iteration model q(z|x; θⁱ⁻¹) as if the samples were gold but weighted by V (z, x) to reflect their possible imperfection. Such an offline update can allow for trivial parallelization of sampling and very delayed communication between the sampler and optimizer, which can permit the use of normal disk storage for V (z, x) values (displayed in FIG. 5). The large variance of V (z, x) as an estimate can be problematic, and thus, the implementation herein can comprise the following two adjustments based on reinforcement. First, the reward can be normalized as

$$A ( z , x ) = \frac{V ( z , x ) - μ}{σ}$$

where μ and σ are the mean and standard deviation of the reward across all N samples drawn from q(z|x; ϕⁱ⁻¹). Second, V (z, x) can be substituted by a bounded surrogate objective:

$${r}_{{z}_{n}} = \frac{q ( {z}_{n} \vert x ; {ϕ}^{i} )}{q ( {z}_{n} \vert x ; {ϕ}^{i - 1} )}$$

R(z, x)=min(r_{z}_{ₙ}A(z, x), (min(max(r₂_{ₙ}, 1−ϵ), 1+ϵ) A(z, x)) A(z, x))

where ϵ is a small constant (ϵ=0.2 in our experiments). The bounded objective can limit the change to q (z|x; ϕ) at each training iteration, thus helping to avoid catastrophic forgetting.

The optimization of θ can be carried out with a simple count-based maximum likelihood estimator with smoothing factor τ and a strong factorization into parts, e.g., subexpressions p(z; θ)=π_{sϵparts(z)} p(s; θ) with

$$p ( s ; θ ) = {θ}_{s} = \frac{{Θ}_{s}}{{\sum }_{{s}^{′} ∈ {𝒟}_{S}} {Θ}_{{s}^{′}}} ,$$

wherein s∈ parts(z) represents all subtrees of the input logical form. For example, when the target forms are sets of triples (as in WebNLG), a subtree can correspond to an individual triple. Θₛ can contain a count of the number of times part s was observed in the entire corpus and can be initialized with τ, and Dₛ can be the set of all data types.

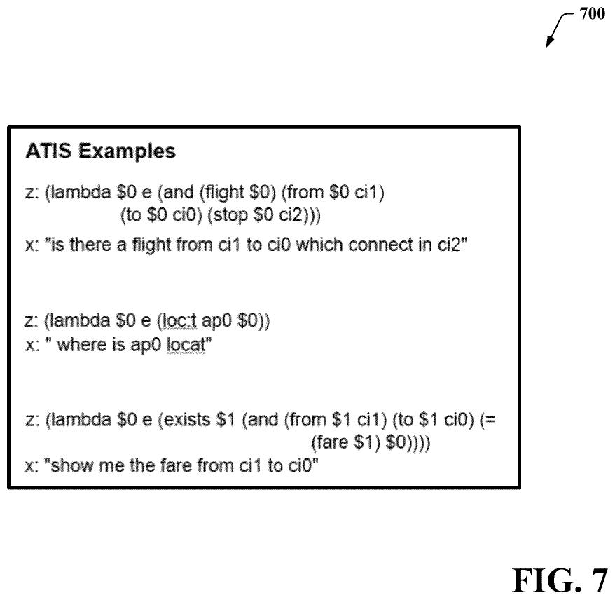

FIG. 6 illustrates a diagram of example, non-limiting text and structure pairs 600 from a WebNLG dataset and structure 610 showing a text-to-RDF example for a WebNLG dataset, and FIG. 7 illustrates a diagram of example, non-limiting text and structure pairs 700 from an ATIS dataset in accordance with one or more embodiments described herein. One or more embodiments described with respect to FIGS. 6 and 7 can be performed by one or more components of FIG. 1. Repetitive description of like elements and/or processes employed in respective embodiments is omitted for sake of brevity.

With continued reference to FIG. 5, FIG. 6 illustrates examples of text, x, and structure, z, from a WebNLG dataset used to test system 500 for both, text-to-structure conversion, and structure-to-text conversion. WebNLG is a DBpedia-based text-to-structure and structure-to-text dataset. For testing system 500, the WebNLG dataset was clustered into semantic categories (e.g., airport, location, athletic activity, etc.), with 16 categories shared between training and testing, and 3 new categories introduced during testing. Thus, the test data comprised entities (such as, for example, AFC, Ajax, etc.) unseen by system 500 in the training data to test generalization of system 500 for predicting previously unseen entities. System 500 was experimentally tested for accuracy on producing a structure, z, from the WebNLG dataset, given a corresponding text, x, from the WebNLG dataset. For example, given a text, x, from the WebNLG dataset, system 500 was employed to predict a corresponding structure, z, and closeness of the z predicted by system 500 to the x provided to system 500 was assessed for determining performance of system 500.

FIG. 6 further illustrates structure 610 showing a text-to-RDF example generated by system 500 for the sentence, “Aarhus airport is in Tristrup, Denmark which is part of the Central Denmark region.” The logical form illustrated by structure 610 can be further written as:
<AarhusAirport, location, Tirstrup>
<Tirstrup, isPartOf, Denmark>
<Tirstrup, isPartOf, CentralDenmark>

Likewise, FIG. 7 illustrates examples of text, x, and structure, z, from an ATIS dataset used to test system 500. ATIS is a traditional, k-calculus semantic parsing dataset. For testing system 500 on the ATIS dataset, an experimental setup employed by the StructVAE method was employed, and results generated by system 500 were compared to results generated by the StructVAE method for the benchmark. Listed below are examples from both, the WebNLG and the ATIS datasets employed for the experiments conducted with respect to the various embodiments herein, followed by a description of the experiments. In addition, how the parts(z) function can break down a logical form has also been described herein.

RDF examples from the WebNLG corpus:

```
Text x:
  “The Aarhus is the airport of Aarhus, Denmark.”
Logical Form z:
  (<S> Aarhus Airport <R> city served <O> “Aarhus, Denmark”)
parts(z):
  { (<S> Aarhus Airport <R> city served <O> “Aarhus, Denmark”) }
λ-calculus examples from the ATIS corpus:
Text x:
  “is there a flight from ci1 to ci0 which connect in ci2”
Logical Form z:
  (lambda $0 e (and (flight $0) (from $0 ci1) (to $0 ci0) (stop $0 ci2)))
parts(z):
  { (flight $0), (from $0 ci1), ... }
Text x:
  “where is ap0 locat”
Logical Form z:
  (lambda $0 e (loc:t ap0 $0))
parts(z):
  { (loc:t ap0 $0), (lambda $0 e (loc:t ap0 $0)) }
Text x:
  “show me the fare from ci1 to ci0”
Logical Form z:
  (lambda $0 e (exists $1 (and (from $1 ci1) (to $1 ci0) (= (fare $1) $0))))
parts(z):
{ (= (fare $1) $0), (fare $1), ... }
```

### Experiments

An extensive series of evaluations were performed utilizing two datasets, an English version of the WebNLG2020+ dataset, and the ATIS dataset. Primary goals of the experiments were to determine if LOCCO can produce an effective semantic parser and assess the contribution of each component of LOCCO to semantic parsing performance. Additionally, an aim of the experiments was also to determine if the outputs of LOCCO could be used to train a reasonable text generation system. For WebNLG, a comparison with recent systems in both parsing and generation, including state-of-the art systems, was included. A self-learning baseline, component ablation, and investigation into the effect of iterative training was also included. For ATIS, an effect of training data size on performance was assessed.

### Datasets:

WebNLG is a dataset wherein each example is a pairing of text with a set of RDF triples. The dataset contains 13,211 training pairs, 1,667 validation pairs (dev set size), 2,155 pairs for testing semantic parsing, and 1,779 pairs for testing text generation. WebNLG was used for the experiments performed in connection with the various embodiments herein because WebNLG is a well-known, open-domain benchmark with several systems to compare against, and WebNLG can test both semantic parsing and text generation. For the WebNLG experiments herein, silver data consisted of 50,000 sentences randomly selected from the TekGen corpus. TekGen is a large-scale dataset intended to provide a more realistic testbed for knowledge extraction, and TekGen is comprised of text instances from Wikipedia that have been annotated with a state-of-the-art RDF triple semantic parser. Since the LLM-based system (e.g., developed using system 100) disclosed herein can intend to operate with unlabeled data, only the text from examples extracted from the corpus was used.

ATIS is a semantic parsing dataset where each example is a pairing of text with a λ-calculus logical form. The ATIS dataset consists of 4,434 training pairs, 490 validation pairs (dev set size), and 447 test pairs. For experiments involving the ATIS dataset, the StructVAE experimental setup was used, wherein the training set was split into two disjoint subsets of varying sizes. One of the subsets was treated as the gold dataset (i.e., keeping both the text and logical form) and the other was considered the silver dataset (i.e., keeping only the text). Doing so allowed for testing a performance of LOCCO for different data sizes and demonstrated how the LOCCO approach can generalize to more complex meaning representations than straightforward RDF-triples. StructVAE results are also provided for completeness and comparison. It is to be noted that since StructVAE preceded the use of LLMs, the LOCCO method can demonstrate superior performance as compared to the StructVAE method.

For both WebBLG and ATIS datasets, minimal processing was performed. The parentheses of each logical form were replaced with <SE> and </SE> tags to demarcate expression boundaries, and each text-to-structure and structure-to-text example was respectively prompted with either “Text to Graph:” or “Graph to Text:”. For WebNLG, the following transformations were applied to each example: 1) The subject, relation, and object were marked with <S>, <R>, and <O> tags, respectively and 2) the camel-cased text of each triple element was split into individual words based on capitalization. For WebNLG, the provided evaluation scripts were used to assess performance. For semantic parsing, there were four types of scored matches, however, for space, an Exact Match metric is displayed in the results section along with a full table of results. For text generation, results for BLEU, METEOR, and chrF++ are provided, with BLEU being the primary metric. With ATIS, exact-match accuracy was reported, wherein the exact-match accuracy indicated whether or not the generated form exactly matched the target.

### Training Details:

For all experiments, pretrained BART-large was used as the model. The semantic parser (e.g., semantic parser 312) was taken to be the model produced at the last iteration of semi-supervised training. For each iteration, the model was evaluated on validation data after every 2500 update steps, and only the top performing model was kept. For the text generation experiments, the training setup was kept as simple as possible. The final model from text-to-structure training was first used to generate a new set of data (following the same setup as each of the prior iterations). Thereafter, the generated annotations were flipped, converting each pair (x, z) into (z, x). Following the conversion, a BART-large model was trained from scratch on the sampled annotations in a manner similar to the one used for the semantic parsing experiments.

### Hyperparameters and Hardware Details:

Table 4 lists hyperparameters used for the training.

TABLE 4
Hyperparameters for WebNLG and ATIS

| Hyperparameter | WebNLG | ATIS |
|---|---|---|
| Dropout | 0.0 | 0.0 |
| Batch size | 8 | 8 |
| Learning rate | 5e−6 | 5e−6 |
| Training iterations | 3 | 3 |
| Training epochs per iteration | 1 | 100 |
| Patience | 5 | 5 |
| Temperature | 1.0 | 1.0 |
| Top-p | 0.95 | 0.95 |
| Number of samples N | 5 | 5 |

For hyperparameter choices, the batch size and learning rate were chosen based on common defaults for the BART-large model. Sampling-based parameters (i.e., temperature, top-p, and number of samples N) were similarly chosen based on RL-based works. Dropout was deactivated to reduce a possible source of randomness in the results after observing that it had no effect on validation performance. The number of epochs to run per training iteration were chosen after observing that BART overfit the dataset (in the case of WebNLG) or saturated in performance (in the case of ATIS) on validation data around that point.

In terms of hardware, the experimental setup herein utilized a high-performance computing (HPC) cluster with central processing unit (CPU) and graphics processing unit (GPU) machines running Red Hat Enterprise Linux release 8.7 (Ootpa). CPU machines were used for all non-neural preprocessing and GPU machines were used for model training. Both, CPU and GPU machines, had 2 CPU cores and 100 GB of RAM. GPU machines ran an NVIDIA V100 Tensor Core GPU with 40 GB of GPU memory.

### Results:

### WebNLG:

The main results of the experiments described above can be found in Tables 2a and 2b that show performance, of the model provided by the various embodiments herein, for both semantic parsing and text generation as compared to other approaches. As can be evident from Table 2a, the LOCCO method can achieve a state-of-the-art performance on the semantic parsing task, with a notable improvement (0.13 F1) over the next best model ReGen. Moreover, the model presented herein can achieve the results without any special modifications to the underlying LLM (e.g., constrained output, triple reordering, etc.), wherein such modifications can be common to the other approaches on this dataset. In Table 2b, it can be evident that the approach described by the various embodiments herein can yield a reasonably performant text generation system, and the approach can outperform all other approaches (many of which were specifically designed for RDF-to-text) but ReGen. The results are significant because the text generation system used herein is functionally a byproduct of the process for producing a semantic parser. The text generation system has no tailored architectural features and is simply trained using data produced by the semantic parser.

Table 2 (2a and 2b): WebNLG test set results for semantic parsing (F1 Strict) and text generation (BLEU, METEOR, chrF++). The gap row includes existing results in comparison with LOCCO.

WebNLG can measure semantic parsing performance with 4 different metrics, each reflecting a degree of match quality. The 4 metrics are Exact, Entity Type, Partial, and Strict. Tables 3 and 5 show results for all 4 metrics (including the text generation metrics for ease of reference).

TABLE 2(a)
Semantic parsing ranked by F1

| Method | F1 | Precision | Recall |
|---|---|---|---|
| LOCCO | 0.736 | 0.729 | 0.749 |
| ReGen | 0.723 | 0.714 | 0.738 |
| Grapher | 0.709 | 0.702 | 0.720 |
| Amazon AI | 0.689 | 0.689 | 0.690 |
| bt5 | 0.682 | 0.670 | 0.701 |
| CycleGT | 0.342 | 0.338 | 0.349 |
| Baseline | 0.158 | 0.154 | 0.164 |

TABLE 2(b)
Text generation ranked by BLEU

| Method | BLEU | Meteor | chrF++ |
|---|---|---|---|
| ReGen | 0.563 | 0.425 | 0.706 |
| LOCCO | 0.552 | 0.406 | 0.691 |
| Amazon AI | 0.540 | 0.417 | 0.690 |
| OSU NLG | 0.535 | 0.414 | 0.688 |
| FBConvAI | 0.527 | 0.413 | 0.686 |
| bt5 | 0.517 | 0.411 | 0.679 |
| NUIG-DSI | 0.517 | 0.403 | 0.669 |
| cuni-ufal | 0.503 | 0.398 | 0.666 |
| CycleGT | 0.446 | 0.387 | 0.637 |
| Baseline | 0.406 | 0.373 | 0.621 |
| RALI | 0.403 | 0.386 | 0.634 |

TABLE 3
Full WebNLG results for semantic parsing

| Method | Match | F1 | Precision | Recall |
|---|---|---|---|---|
| ReGen | Exact | 0.723 | 0.714 | 0.738 |
| | Entity Type | 0.807 | 0.791 | 0.835 |
| | Partial | 0.767 | 0.755 | 0.788 |
| | Strict | 0.720 | 0.713 | 0.735 |
| Grapher | Exact | 0.709 | 0.702 | 0.720 |
| | Entity Type | — | — | — |
| | Partial | 0.735 | 0.725 | 0.750 |
| | Strict | 0.706 | 0.700 | 0.717 |
| Amazon AI | Exact | 0.689 | 0.689 | 0.690 |
| | Entity Type | 0.700 | 0.699 | 0.701 |
| | Partial | 0.696 | 0.696 | 0.698 |
| | Strict | 0.686 | 0.686 | 0.687 |
| bt5 | Exact | 0.682 | 0.670 | 0.701 |
| | Entity Type | 0.737 | 0.721 | 0.762 |
| | Partial | 0.713 | 0.700 | 0.736 |
| | Strict | 0.675 | 0.663 | 0.695 |
| CycleGT | Exact | 0.342 | 0.338 | 0.349 |
| | Entity Type | 0.343 | 0.335 | 0.356 |
| | Partial | 0.360 | 0.355 | 0.372 |
| | Strict | 0.309 | 0.306 | 0.315 |
| Baseline | Exact | 0.158 | 0.154 | 0.164 |
| | Entity Type | 0.193 | 0.187 | 0.202 |
| | Partial | 0.200 | 0.194 | 0.211 |
| | Strict | 0.127 | 0.125 | 0.130 |
| LOCCO | Exact | 0.736 | 0.729 | 0.749 |
| | Entity Type | 0.808 | 0.796 | 0.829 |
| | Partial | 0.775 | 0.766 | 0.793 |
| | Strict | 0.733 | 0.726 | 0.745 |

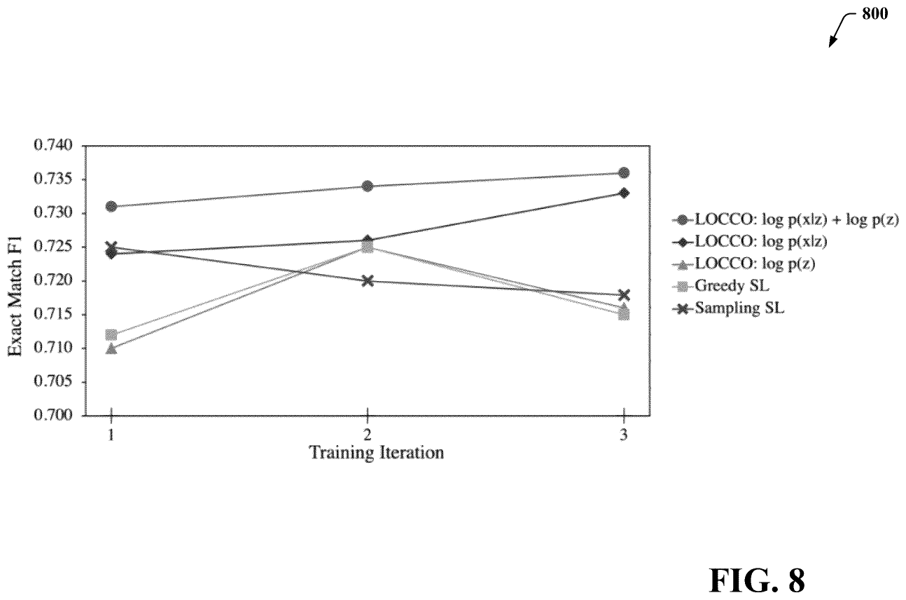

FIG. 8 illustrates an example, non-limiting graph 800 showing results of a semantic parsing performance across training iterations in accordance with one or more embodiments described herein. One or more embodiments described with respect to FIG. 8 can be performed by one or more components of FIG. 1. Repetitive description of like elements and/or processes employed in respective embodiments is omitted for sake of brevity.

In addition to the main experiments described with reference to FIG. 7, extensive ablation experiments were also performed in connection with the various embodiments disclosed herein to determine contributions of each element of the training objective. Table 4 shows various ablations to the reward function of the model disclosed herein, self-learning (SL), wherein the annotated silver parses were drawn from either greedy or sampling-based decoding, and gold-only training, wherein no silver data was used. From Table 4, it can be evident that using silver data in any capacity can lead to improved performance of the LLM-based system over gold-only training. This can be a promising result, as it ca suggests that the approach disclosed herein can be used to improve the other models not trained with external data. The results can indicate that greedy and count-based rewards can produce roughly the same performance, which can be described as somewhat unsurprising because the count-based model should reward higher-probability triples that can be sampled frequently (i.e., those that would be produced by greedy decoding). The most significant result is that the combination of cycle consistency and the count-based logic model can produce the best performance, that is, better than either score, individually.

TABLE 4
WebNLG ablation results for semantic parsing
(in terms of Exact Match) and text generation

| | | Semantic Parsing | | | Text Generation | | |
|---|---|---|---|---|---|---|---|
| Method | Reward Function | F1 | Precision | Recall | BLEU | Meteor | chrF++ |
| LOCCO | log p(x\|z) + log p(z) | 0.736 | 0.729 | 0.749 | 0.552 | 0.406 | 0.691 |
| LOCCO | log p(x\|z) | 0.733 | 0.725 | 0.745 | 0.551 | 0.416 | 0.692 |
| LOCCO | log p(z) | 0.716 | 0.710 | 0.728 | 0.519 | 0.405 | 0.676 |
| Greedy SL | — | 0.715 | 0.708 | 0.726 | 0.507 | 0.401 | 0.663 |
| Sampling SL | — | 0.718 | 0.712 | 0.728 | 0.524 | 0.407 | 0.677 |
| Gold-Only | — | 0.691 | 0.684 | 0.703 | 0.526 | 0.406 | 0.678 |

TABLE 5
Full WebNLG ablation results. In Table 5, RF represents reward function, E represents
Exact, ET represents Entity Type, P represents Partial, and S represents Strict.

| | | Semantic Parsing | | | | Text Generation | | |
|---|---|---|---|---|---|---|---|---|
| Method | RF | Match | F1 | Precision | Recall | BLEU | Meteor | chrF++ |
| LOCCO | log p(x\|z) + | E | 0.736 | 0.729 | 0.749 | 0.552 | 0.406 | 0.691 |
| | log p(z) | ET | 0.808 | 0.796 | 0.829 | | | |
| | | P | 0.775 | 0.766 | 0.793 | | | |
| | | S | 0.733 | 0.726 | 0.745 | | | |
| LOCCO | log p(x\|z) | E | 0.733 | 0.725 | 0.745 | 0.551 | 0.416 | 0.692 |
| | | ET | 0.804 | 0.791 | 0.825 | | | |
| | | P | 0.771 | 0.761 | 0.788 | | | |
| | | S | 0.729 | 0.722 | 0.742 | | | |
| LOCCO | log p(z) | E | 0.716 | 0.710 | 0.728 | 0.519 | 0.405 | 0.676 |
| | | ET | 0.798 | 0.786 | 0.818 | | | |
| | | P | 0.760 | 0.751 | 0.777 | | | |
| | | S | 0.712 | 0.705 | 0.723 | | | |
| Greedy SL | — | E | 0.715 | 0.708 | 0.726 | 0.507 | 0.401 | 0.663 |
| | | ET | 0.786 | 0.775 | 0.805 | | | |
| | | P | 0.755 | 0.745 | 0.770 | | | |
| | | S | 0.708 | 0.702 | 0.719 | | | |
| Sampling SL | — | E | 0.718 | 0.712 | 0.728 | 0.524 | 0.407 | 0.677 |
| | | ET | 0.785 | 0.775 | 0.802 | | | |
| | | P | 0.755 | 0.747 | 0.769 | | | |
| | | S | 0.713 | 0.707 | 0.723 | | | |
| Gold-Only | — | E | 0.691 | 0.684 | 0.703 | 0.526 | 0.406 | 0.678 |
| | | ET | 0.762 | 0.750 | 0.783 | | | |
| | | P | 0.732 | 0.722 | 0.749 | | | |
| | | S | 0.684 | 0.677 | 0.696 | | | |

### Performance Across Epochs:

FIG. 8 illustrates semantic parsing performance across training iterations as measured by Exact Match F1. Although the main results were based on the model trained at the final iteration, a performance of each model in the intermediate iterations of training was also observed. Graph 800 illustrates the across-iteration performance, and it can be evident from graph 800 that the unablated version of LOCCO can demonstrate a consistently higher performance than the other versions. Additionally, as remarked elsewhere herein, it can be evident that sampling-based self-learning can produce strong results at first but degenerate over time. It can also be observed that greedy self-learning is largely equivalent in performance to LOCCO when only the prior p(z) is used for the reward. It is possible that such a result can be caused due to the nature of the count-based model that can upweight logical forms with frequent triples, that is, those considered more likely by the neural model disclosed by embodiments of the present disclosure, and thus more likely to also be a part of the greedy decoding.

### ATIS:

Table 6 shows results on the ATIS semantic parsing dataset as compared to StructVAE. The first column of Table 6 shows the size of the gold dataset, D^{s}, while the remaining columns provide results for each system. For both LOCCO and StructVAE, the results distinguish between training with gold-only (i.e., only examples in D^{S} used), self-learning, and R(z, x) (i.e., when all silver examples are scored) settings. In addition, a current method was included for reference. LOCCO can demonstrate performance gains over both the supervised and self-learning settings (with the exception of |D^{S}|=500), which can suggest that, the approach disclosed by the various embodiments herein can produce more meaningful annotations of the unlabeled data than pure self-learning. This can be significant because the target meaning representation, k-calculus, can be significantly more complex than the representations applicable to WebNLG. It is to be noted that the results for LOCCO can be achieved with offline sampling and scoring, whereas other methods can involve sampling during training. As such, one objective of the experiments conducted with respect to the various embodiments herein was to compare gains of the LOCCO method with those of the supervised and self-learning settings. An overall improvement demonstrated by the model herein, as compared to some existing methods, can be attributed to a much stronger pretrained model employed by the various embodiments herein (e.g., as opposed to an LSTM with GLOVE embeddings) that can provide a better baseline performance.

TABLE 6
Semantic parsing on ATIS for various training set sizes. The last
row of Table 6 reflects a scenario when all supervised data is used
(i.e., there is no additional data for semi-supervised training).

| | LOCCO | | | StructVAE | | | |
|---|---|---|---|---|---|---|---|
| | Gold- | Self- | | Gold- | Self- | | |
| \|D^{S}\| | Only | Learning | R(z, | Only | Learning | R(z, | SOTA |
| 500 | 71.9 | 76.8 | 75.9 | 63.2 | 65.3 | 66.0 | — |
| 1000 | 77.0 | 77.9 | 81.0 | 74.6 | 74.2 | 75.7 | — |
| 2000 | 86.1 | 86.4 | 87.1 | 80.4 | 83.3 | 82.4 | — |
| 3000 | 85.9 | 87.3 | 87.7 | 82.8 | 83.6 | 83.6 | — |
| 4434 | 86.3 | — | — | 85.3 | — | — | 89.1 |

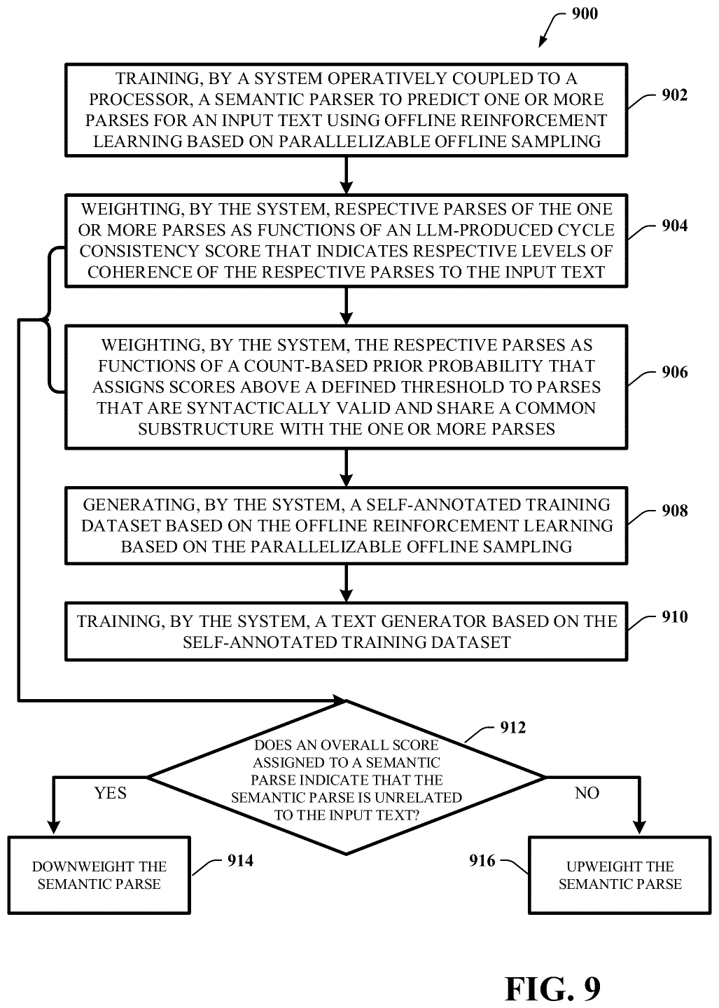

FIG. 9 illustrates a flow diagram of an example, non-limiting method 900 that can enable learning a semantic parser with semi supervision using cycle consistency and a probabilistic reasoner in accordance with one or more embodiments described herein. One or more embodiments described with respect to FIG. 9 can be performed by one or more components of FIG. 1. Repetitive description of like elements and/or processes employed in respective embodiments is omitted for sake of brevity.

At 902, the non-limiting method 900 can comprise training (e.g., by training component 108), by a system operatively coupled to a processor, a semantic parser to predict one or more parses for an input text using offline reinforcement learning based on parallelizable offline sampling.

At 904, the non-limiting method 900 can comprise weighting (e.g., by weighting component 110), by the system, respective parses of the one or more parses as functions of an LLM-produced cycle consistency score that can indicate respective levels of coherence of the respective parses to the input text.

At 906, the non-limiting method 900 can comprise weighting (e.g., by weighting component 110), by the system, the respective parses as functions of a count-based prior probability that can assign scores above a defined threshold to parses that are syntactically valid and share a common substructure with the one or more parses.

At 908, the non-limiting method 900 can comprise generating, by the system, a self-annotated training dataset based on the offline reinforcement learning based on the parallelizable offline sampling.

At 910, the non-limiting method 900 can comprise training (e.g., by training component 108), by the system, a text generator based on the self-annotated training dataset.

At 912, the non-limiting method 900 can comprise determining (e.g., by weighting component 110), by the system, whether an overall score (i.e., a sum of the LLM-based cycle consistency score and a count-based score) assigned to a semantic parse can indicate that the semantic parse is unrelated to the input text.

If yes, at 914, the non-limiting method 900 can comprise down weighting (e.g., by weighting component 110), by the system, the semantic parse.

If no, at 916, the non-limiting method 900 can comprise upweighting (e.g., by weighting component 110), by the system, the semantic parse.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively generate structured representations from a large amount of unannotated text and assign scores to the structured representations as the one or more embodiments described herein can enable this process. And, neither can the human mind nor a human with pen and paper weigh scores assigned to structured representations generated by a semantic parser to generate a large amount of training data for training the semantic parser using offline reinforcement learning based on parallelizable offline sampling, as conducted by one or more embodiments described herein.

In summary, various embodiments herein can enable LOCCO, a semi-supervised method for training a neural semantic parser. Approaches described herein can bootstrap a neural semantic parser, by using the neural semantic parser to predict a structure latent to text-only data and subsequently using the predictions as training data. A cycle consistency-based scoring function can bias the model towards producing useful parses by weighting each predicted parse as a function of both a conditional likelihood of the input given the parse as well as the conditional likelihood of the parse itself. An offline nature of the approaches described herein can make the approaches inherently suitable to parallelization, which can allow LOCCO to be easily scaled to large amounts of data. Initially, the neural semantic parser can be trained in a supervised fashion with a limited amount of data. Following the supervised training, the neural semantic parser can be provided with a large corpus of text-only data, and a set of logical forms can be sampled from the neural semantic parses for each text-only example. A score of each sample can be a function of a probability of the text, given the logical form and an unconditional probability of the logical form itself. Each score sample can become a weight of a training example. That is, a weighted cross entropy loss can be used, wherein the weight of each training example can be considered the sample score. LOCCO can be scalable, utilize powerful pretrained LLMs, and incorporate inductive biases relevant to a formal domain.

As described above, LOCCO can be trained using offline reinforcement learning, which can make LOCCO parallelizable. LOCCO can involve sending disjoint partitions of data to different GPUs to be annotated in parallel, after which, results of the sampling can be collected and scored, and the score parses can be used as training data. Because LOCCO can produce parses for an entire corpus of text-only data, a probabilistic reasoner can be further learnt for an unconditional probability of the logical form. In various embodiments, a counts-based reasoner can be used, which can indicate frequency of a component of a generated logical form across the whole dataset. An effectiveness of LOCCO was experimentally demonstrated on two standard benchmark datasets, wherein LOCCO achieved strong performance for both semantic parsing and text generation. Experiments conducted in connection with the various embodiments herein demonstrated how a weakly-supervised output of LOCCO can be repurposed to train a strong text generation model and demonstrate effectiveness of LOCCO on the well-known WebNLG 2020 benchmark. Results based on the WebNLG 2020 dataset demonstrated improvements in semantic parsing by 1.3 points over a previous parser known in the art, while also achieving competitive text generation performance. Experiments conducted in connection with the various embodiments also compared LOCCO to similar semi-supervised models on the standard ATIS semantic parsing benchmark, results of which demonstrated competitive performance of LOCCO without the need for expensive online sampling. An ablation analysis was also performed to determine how each component of LOCCO can contribute to an overall performance of LOCCO.

FIG. 10 illustrates a block diagram of an example, non-limiting operating environment 1000 in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as Logical Offline Cycle Consistency Optimization code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer-executable components; and
a processor that executes the computer-executable components stored in the memory, wherein the computer-executable components comprise:
a training component that trains a semantic parser to predict one or more parses for an input text using offline reinforcement learning based on parallelizable offline sampling.

2. The system of claim 1, further comprising:
a weighting component that weights respective parses of the one or more parses as functions of a large language model (LLM)-produced cycle consistency score that indicates respective levels of coherence of the respective parses to the input text.

3. The system of claim 2, wherein weighting the respective parses of the one or more parses as functions of an LLM-produced cycle consistency score results in a model that produces parses that are coherent with respect to the input text.

4. The system of claim 2, wherein the weighting component further weights the respective parses as functions of a count-based prior probability that assigns scores above a defined threshold to parses that are syntactically valid and share a common substructure with the one or more parses.

5. The system of claim 4, wherein weighting the respective parses as functions of the count-based prior probability results in a model that produces structurally regular parses.

6. The system of claim 1, wherein the offline reinforcement learning based on the parallelizable offline sampling generates a self-annotated dataset.

7. The system of claim 6, wherein a text generator is trained on the self-annotated dataset.

8. A computer-implemented method, comprising:
training, by a system operatively coupled to a processor, a semantic parser to predict one or more parses for an input text using offline reinforcement learning based on parallelizable offline sampling.

9. The computer-implemented method of claim 8, further comprising:
weighting, by the system, respective parses of the one or more parses as functions of an LLM-produced cycle consistency score that indicates respective levels of coherence of the respective parses to the input text.

10. The computer-implemented method of claim 9, wherein the weighting results in a model that produces parses that are coherent with respect to the input text.

11. The computer-implemented method of claim 9, further comprising:
weighting, by the system, the respective parses as functions of a count-based prior probability that assigns scores above a defined threshold to parses that are syntactically valid and share a common substructure with the one or more parses.

12. The computer-implemented method of claim 11, wherein the weighting results in a model that produces structurally regular parses.

13. The computer-implemented method of claim 8, further comprising:
generating, by the system, a self-annotated training dataset based on the offline reinforcement learning based on the parallelizable offline sampling.

14. The computer-implemented method of claim 13, further comprising:
training, by the system, a text generator based on the self-annotated training dataset.

15. A computer program product for semantic parsing and text generation, the computer program product comprising a computer readable storage medium having program instructions embodied therewith, the program instructions executable by a processor to cause the processor to:
train, by the processor, a semantic parser to predict one or more parses for an input text using offline reinforcement learning based on parallelizable offline sampling.

16. The computer program product of claim 15, wherein the program instructions are further executable by the processor to cause the processor to:
weight, by the processor, respective parses of the one or more parses as functions of an LLM-produced cycle consistency score that indicates respective levels of coherence of the respective parses to the input text.

17. The computer program product of claim 16, wherein weighting the respective parses of the one or more parses as functions of an LLM-produced cycle consistency score results in a model that produces parses that are coherent with respect to the input text.

18. The computer program product of claim 16, wherein the program instructions are further executable by the processor to cause the processor to:
weight, by the processor, the respective parses as functions of a count-based prior probability that assigns scores above a defined threshold to parses that are syntactically valid and share a common substructure with the one or more parses.

19. The computer program product of claim 18, wherein weighting the respective parses as functions of the count-based prior probability results in a model that produces structurally regular parses.

20. The computer program product of claim 15, wherein the program instructions are further executable by the processor to cause the processor to:
generate, by the processor, a self-annotated training dataset based on the offline reinforcement learning based on the parallelizable offline sampling; and
train, by the processor, a text generator based on the self-annotated training dataset.
